(19) United States
(12) Patent Application Publication
(10) Pub. No.: US 2015/0237851 A1
(43) Pub. Date: Aug. 27, 2015

(54) SPRAY DRIFT ADJUVANT FORMULATION AND METHOD OF USE

(71) Applicant: VITEL AUSTRALIA PTY LTD, Warrendyte (AU)

(72) Inventor: Daniel Drew, Warrandyte (AU)

(73) Assignee: VITEL AUSTRALIA PTY LTD, Warrandyte (AU)

(21) Appl. No.: 14/426,878

(22) PCT Filed: Sep. 9, 2013
(86) PCT No.: PCT/AU2013/001016

§ 371 Date: Mar. 9, 2015

(30) Foreign Application Priority Data
Sep. 11, 2012 (AU) 2012903953
Nov. 28, 2012 (AU) 2012905178

(51) Int. Cl. A01N 25/10; A01N 57/20; A01N 25/30

(52) U.S. Cl. CPC A01N 25/10; A01N 25/30; A01N 57/20

(57) ABSTRACT

A spray liquid adjuvant comprising a spray drift agent dispersed in a non-ionic surfactant.

### FIELD OF INVENTION

The present invention relates to the field of retarding spray drift when a liquid is applied as a spray to a locus. In particular the invention relates to retarding spray drift in applications that require spray application of an active such as an agricultural, horticultural, pharmaceutical, cosmetic or veterinary active.

In one form, the invention relates to a spray drift retardant formulation for addition to spray liquids.

In one particular aspect the present invention is suitable for use in the formulation of spray liquids.

While the present invention will be described with particular reference to spray drift control for agricultural or horticultural formulations, it should be appreciated that the present invention is not so limited and can be used for other applications including industrial and medical/veterinary applications.

Furthermore, while the present invention will be described with particular reference to visco-elastic polyacrylamides (PAMs) as spray drift retardants, it should be appreciated that the present invention is not so limited and can be used with other spray drift retardants including, but not limited to, polyethylene oxides, poly(vinyl pyrrolidones), guar-gum compounds, soy lecithin compounds, and cellulosic materials such as carboxymethyl cellulose.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Spray Drift:

Many liquids are applied to a locus in the form of a spray. Spray application processes are used in many industrial applications such as aerial fire fighting, dust control, gas scrubbing, crude oil spill treatments and agricultural applications such as treating crops with bio-actives. These sprays are typically discharged from moving vehicles such as aircraft, tractors, ground rigs or railcars.

One of the problems associated with spray application is ‘spray drift’ which occurs when mist or fine droplets of spray do not reach the intended target. Spray drift is the physical movement of spray droplets (and their dried remnants) through the air from the spray applicator nozzle to any off-target site at the time of application or soon thereafter. Where used herein, the term ‘spray drift’ does not include secondary movement of spray components to off-target sites due to volatility, erosion, surface or groundwater transport or wind transport of particles that occurs after spray application.

The off-target material is typically ineffective, wasted and constitutes an economic loss. In agricultural applications, the bio-actives and other chemicals in spray drift can be of environmental concern if they cause air or water pollution, potentially causing hazards for crops, water supplies and livestock in the vicinity of the target. Farmers and agricultural chemical suppliers are becoming increasingly aware of the problems associated with spray drift. Furthermore agricultural and environmental authorities are tightening regulation relating to spray drift management.

Spray Drift Control Agents:

Spray droplet size is a major factor affecting drift. While small droplets provide better coverage of a target, they are more susceptible to drift than larger droplets. Efforts have been made in the past to reduce spray drift by improving spray equipment design, such as, for example, altering nozzle design to optimise spray patterns, or optimising application parameters such as spray pressure, heights, shrouds and formulations. One of the more promising formulation improvements has been the use of droplet size range modifiers called ‘drift control agents’.

Effective drift control agents preferably have as many as possible of the following characteristics:
cause increase in small droplet size,
are insensitive to high shear in the spray system,
do not detract from the performance of spray bio-actives,
are compatible with other spray adjuvants,
are compatible with spray actives,
do not separate upon standing,
are easy to store, handle and use,
are environmentally friendly, and
are cost efficient.

Spray drift control agents are typically high molecular weight polymers which, tend to increase the viscosity of aqueous systems and thus prevent the water from being broken up into a fine mist when sprayed. For example, visco-elastic polyacrylamides (PAMs), polyethylene oxides, poly(vinyl pyrrolidones), guar-gum compounds, soy lecithin compounds, and cellulosic materials such as carboxymethyl cellulose are typical spray drift control agents.

Normal practice is to mix the polymer as a powder, aqueous, viscous concentrate or reverse phase emulsion with water (eg in a spray tank) so as to form an aqueous solution of polymer. However, aqueous polymer concentrates and, emulsion polymers can be difficult to activate in this situation and polymer powders take a long time to dissolve.

While linear PAMs are well known as drift retardant agents, they also have some characteristics that make them difficult to use, such as being very difficult to dissolve in water, often taking several hours to fully hydrolyse. Australian patent AU 2002311857 (Wallace & Arnold) notes that rapid water solubility can be achieved using particle sizes of <150 micron. However, such small particles tend to agglomerate in water to form clumps and gels which must be broken up to facilitate hydrolysis. Water quality sensitivity can also affect the rate of dissolution. Accordingly, specific organic inverting surfactants are often used with these polymers to enable them to be properly hydrated and dispersed in water. As a consequence in agricultural applications, they are only available to farmers as viscous liquid concentrates which are very difficult to measure handle and mix. In addition PAMs are sometimes distributed as an emulsion in a kerosene carrier which limits the dispersibility and additionally presents a volatile organic component problem for end users. As a result of these difficulties farmers are reluctant to use PAM concentrates.

One of the problems associated with drift control agents of the prior art is that they can be difficult to incorporate into a spray liquid, particularly aqueous spray. The spray actives are usually supplied to farmers as a concentrate that must be diluted with water to form a sprayable composition.

In order to avoid metering difficulties associated with spray drift agents and other adjuvants, it is often preferable to mix the adjuvant with a known volume of water or aqueous composition fed to the spray pumps.

Efforts have been made in the past to improve the characteristics of aqueous solutions or dispersions or spray drift agents. For example U.S. Pat. No. 6,372,842 (Grisso et at) relates to aqueous solutions or aqueous dispersions of PAMs. International application WO 00/26160 (Rose et al) describes a liquid aqueous concentration of PAM with ammonium sulphate and covers commercial products associated with Akzel-R-ate™ and Companion Gold™. International application WO 2008/101818 (Rose et at) also describes liquid aqueous PAM concentrates. Australian patent AU-2002311857 (Wallace & Arnold) describes the use of PAM dispersed in a saturated aqueous solution of ammonium sulphate. Australian patent AU-2010290047 teaches aqueous formulations comprising water-soluble polysaccharide polymer suspended in solution with a hydration inhibitor. Australian patent application AU-2010334679 (Carmichael et al) discloses water-in-oil emulsions of water-soluble polymers in surfactants, the emulsions being made by inverse emulsion polymerisation.

Accordingly, the prevailing wisdom in the art relates to forming PAMs and other spray drift agents into concentrated aqueous (or predominantly aqueous) solutions or emulsions, for incorporation into spray liquid formulations.

Yet more examples exist of the ongoing efforts to formulate compositions that have the required level of stability and other desirable characteristics. US patent application 200210019318 and related U.S. Pat. No. 6,743,756 (Harris) teach formulations comprising liquid water soluble polymer suspensions in non-aqueous solvents and illustrate their stability over long periods of time. U.S. Pat. No. 4,799,962 (Ahmed) discloses particulate water-soluble polymer dispersed in a liquid medium comprised of high and low molecular weight polyethylene glycol, and water. U.S. Pat. No. 4,176,107 (Buckman et al) relates to liquid polymer compositions comprising a high molecular weight water-soluble vinyl addition polymer, water, surfactants and a water-soluble polyalkylene glycol, or water-soluble ethoxylated alcohol, alkylphenol or fatty acid. U.S. Pat. No. 5,362,312 (Skaggs et al) relates to a liquid carrier fluid that is used as a carrier system to suspend and deliver water soluble polymers which act to adjust the rheological properties of the aqueous systems to which they are added.

Wetting Agents:

Wetting agents or ‘wetters’ are often included in spray formulations to promote wetting of a locus and spreading of the active by dramatically reducing surface tension and reducing droplet contact angle. In general, wetting agents help the spray to completely cover the surface of a locus, spreading out instead of beading in droplets. In agricultural and horticultural applications wetting agents are used to promote greater plant surface coverage, adhesion of the spray droplets to hydrophobic surfaces of plants, and the better uptake of actives through penetration of cuticular waxes and stomatal penetration. A larger amount of active ingredient passes onto and into the plant and the active functions more effectively, even under adverse conditions of dusty, hairy or hard to wet plants.

Wetting agents are typically surfactants. Surfactants have a hydrophilic polar head and a hydrophobic long carbon chain tail. The tail of the surfactant molecule can bind with non-polar substances such as the hydrophobic waxes on the surface of some plants. Surfactants can be cationic, anionic or non-ionic. Non-ionic surfactants have the advantage of remaining effective when diluted with dam or bore water containing higher levels of dissolved salts and minerals.

Wetting agents are typically supplied as a neat liquid without solvent. With respect to mixing and use of wetters in agricultural spray liquids, it is usual to combine the wetting agent in the mixing tank where the water is mixed with the active herbicide, pesticide or fertiliser concentrate and/or other spray adjuvants.

There is an ongoing need in the art for compositions that have the appropriate characteristics for specific applications, including compositions that at least partly retard spray drift of spray liquids.

### SUMMARY OF INVENTION

An object of the present invention is to provide an improved dosage form of spray drift reduction agent.

Another object of the present invention is to provide an improved dosage form of wetting agent.

A further object of the present invention is to provide an adjuvant for improving the performance of a spray formulation.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

In a first aspect of embodiments described herein there is provided a spray liquid adjuvant comprising a spray drift agent dispersed in a non-ionic surfactant. Typically the combination of spray drift agent and non-ionic surfactant exhibits a synergistic effect.

In a second aspect of embodiments described herein there is provided a spray liquid adjuvant comprising a spray drift agent at a concentration of between 1 and 50 wt %, preferably between 5 and 40 wt % dispersed in a non-ionic surfactant, the spray drift agent comprising particles of <150 micron, preferably less than 100 micron.

Surfactant:

The surfactant optimally acts as a wetting agent and may be chosen for example, from so called super-wetting tri-siloxanes or surfactants traditionally used for this purpose. The super-wetters include, for example, polyether modified trisiloxanes such as the range of wetters sold under the trade marks ‘Silwet™’ from Momentive Specialty Chemicals Inc. or ‘Breakthru™’ from Evonik Degussa Chemicals.

The combination of spray drift agent and surfactant wetting agent may dramatically reduce the amount of wetting agent needed for optimum performance by up to 70 or 80%. This synergistic effect is particularly apparent when trisiloxane super wetters are used, allowing much lower concentrations of super wetter in the final spray liquid than is usually recommended (the amount of wetter required for good wetting is about 20 to 30% of the recommended rate).

For example if 200 ml/ha is normally used in a spray formulation, only 40 ml/ha is required when the spray drift retardant is combined, thus leading to economic savings and lower likelihood of phytotoxicity because less surfactant is applied to plants. Concomitantly, spray volume can be reduced by up to 30 to 50% saving time, money and environmental resources.

Spray Drift Agent:

Preferably the spray drift agent is a drift retardant polymer formed from water soluble monomer or monomer blend, usually water soluble ethylenically unsaturated monomer. The polymer may be cationic or amphoteric but is preferably non-ionic or anionic. Particularly preferred polymers are non-ionic polymers or anionic polymers containing from about 0.01 wt % up to 40 wt %, preferably up to 30 wt % anionic monomer components.

In a preferred embodiment, the spray drift agent is chosen from the group comprising polyacrylates such as visco-elastic polyacrylamides (PAMs) and Carbopol®-type polyacrylamides, polyethylene oxides, poly(vinyl pyrrolidones), polyvinyl alcohol, guar, guar-gum compounds such as hydroxyalkyl guar, carboxyalkyl guar, carboxyalkyl hydroxyalkyl guar, cationic guar, hydrophobically modified guar, hydrophobically modified hydroxyalkyl guar, hydrophobically modified carboxyalkyl guar, hydrophobically modified carboxyalkyl hydroxyalkyl guar, hydrophobically modified cationic guar, pectin, alginates, locust bean gum, gum Arabic, gum acacia, carrageenan, carboxyalkyl hydroxyalkyl, starch, gum tragacanth, gum karaya, tara gum, xanthan gum, welan gum succinoglucans, soy lecithin compounds, cellulose and cellulosic materials such as hydroxyalkyl cellulose, carboxyalkyl hydroxyalkyl cellulose, carboxyalkyl cellulose, alkyl ethers of cellulose, hydroxyalkyl methyl cellulose, hydrophobically modified hydroxyalkyl cellulose, hydrophobically modified alkyl hydroxyalkyl cellulose, hydrophobically modified carboxyalkyl cellulose, hydrophobically modified alkyl ethers of cellulose, hydrophobically modified hydroxyalkyl methyl cellulose, and derivatives and combinations thereof.

In a particularly preferred embodiment the spray drift agent comprises one or more PAMs. Polyacrylamide (also referred to as poly(2-propenamide) or poly(l-carbamoylethylene)) is a polymer (—CH₂CHCONH₂—) formed from acrylamide. If PAM is used, the surfactant must be a 100% active ingredient with no associated water, such that the PAM remains in the solid state in suspension.

Almost any linear PAM (non-ionic, anionic, cationic) can be used. However if the formulation of the present invention is to be used in an agricultural or horticultural spray it should be noted that the ionic PAMs are incompatible with some agrochemical ingredients. Accordingly the PAM used for these applications should be non-ionic (eg acrylamide homopolymer) or have 40% or less, preferably 30% or less, or more preferably 5% or less to about 0.01% of ionic character, and a molecular mass of 10 to 20 million. Ionically balanced polyacrylamide formulations may also be used.

In one embodiment of the present invention the adjuvant formulation includes both low molecular weight PAM and high molecular weight PAM. U.S. Pat. No. 5,525,575 (Chamberlain) suggests that low molecular weight PAMS added to a sprayable systemic active ingredient may enhance systemic activity but only discloses the use of low molecular weight PAMs to aid absorption of active into foliage.

Additives:

In a further aspect of embodiments described herein the spray liquid adjuvant of the present invention includes one or more additives in addition to the spray drift agent dispersed in a non-ionic surfactant.

The term ‘additives’ where used herein refers to any component added to an active to produce a spray formulation. ‘Adjuvants’ are a type of additive that enhances the performance of a spray solution, in contradistinction to other additives that have other effects such as improving storage characteristics. Adjuvants may also enhance the performance of the active.

Typically, the additives combined with the spray liquid adjuvant of the present invention are chemical moieties that improve storage and handling characteristics and may contribute to formation of dispersion, promote storage stability, or facilitate addition to other components of a liquid spray formulation.

For example, the adjuvants may include additives including chemical moieties for optimisation of pH, viscosity, stability and colour, suppression of foam, or to keep the dispersed particles in suspension in the surfactant. These include, for example, acids, bases, buffers, demulsifiers, non-emulsifiers, foaming agents, antifoaming agents, scale inhibitors, corrosion inhibitors, thickeners, polymer preservatives, bactericides, antioxidants, fluid loss additives, water miscible co-solvents, formation stabilisers, cross-linkers, polymer breakers, gel breakers and combinations thereof.

In a particularly preferred embodiment the composition of the present invention includes thickeners such as those selected from the group consisting of partially neutralised polyacrylic acid, hydroxypropyl cellulose, highly substituted hydroxypropyl guar, hydrated thickening silica including fumed silica and hydrophobic fumed silica, their functional equivalents, and mixtures thereof.

Solids for Dispersion:

The solid particles of spray drift agent used in the adjuvant formulation may be manufactured by any convenient means known to those skilled in the art. Sieving, crushing or grinding may be required to reduce the solid particles to the desired size.

Typically the solid particles will be incorporated into the surfactant by mechanical mixing.

Ideally the wetting agent and spray drift agent are packaged into water-soluble sachets or pods, such as can be manufactured from polyvinyl alcohol, similar to commercially available machine fabric washing surfactants. The relative proportions of wetter, polyacrylamide and pod mass are determined by the recommended quantity of water to be added to form the spray liquid. For example, for an agrochemical application, Table 1 provides a guide:

TABLE 1
Typical formulation proportions

| Spray | | | Approx | Spray solution | |
|---|---|---|---|---|---|
| Tank | PAM | | pod | PAM | Spray solution |
| size | content | Wetter | volume | concentration | wetter |
| (litres) | (g) | content | (mL) | (mg/litre) | concentration (%) |
| 100 | 4 | 16 | 20 | 40 | 0.016 |
| 100 | 8 | 32 | 40 | 80 | 0.032 |
| 1000 | 40 | 160 | 200 | 40 | 0.016 |
| 1000 | 80 | 320 | 400 | 80 | 0.032 |

Spray Liquid Formulation:

The combination spray liquid adjuvant of the present invention may be incorporated into any desired spray liquid formulation.

In a further aspect of embodiments described herein there is provided a spray liquid formulation comprising:
a spray liquid adjuvant according to the present invention,
a carrier solvent,
an active.

In a preferred embodiment the active is chosen from agricultural, horticultural, pharmaceutical or veterinary actives, or combinations thereof. The present invention can be prepared not only with PAM drift retardant, but also may contain other additional active ingredients that are affective at low concentrations. Systemic pesticides such as imidacloprid or growth promoters such as gibberelic acid are active at very low concentrations in a spray solution and so may be included in a combination formulation together with wetter and drift reduction agent.

In another aspect of embodiments described herein there is provided a method of forming a spray formulation comprising the step of combining the liquid spray adjuvant of the present invention with an aqueous spray solution, wherein the spray drift agent concentration is 10 to 200 mg per litre of spray solution, preferably 10 to 80 mg per litre of spray solution, preferably 30 to 60 mg per litre of spray solution. In general, aerial spraying operations require the higher PAM concentrations (as high as 200 mg per litre of, spray solution). Ground-level spray applications, such as those using a boom, require lower PAM concentrations, typically from 10 to 80 mg per litre of spray solution. The required concentration of PAM can be readily achieved by addition of the appropriate number of pods.

In yet a further aspect of embodiments described herein there is provided a method of forming a spray liquid formulation comprising the step of combining an adjuvant according to the present invention with a solvent. Typically the solvent will be a body of water in a spray tank.

For example for agrichemical applications, the method of forming a spray liquid formulation will comprise the steps of:
(I) providing an adjuvant according to the present invention;
(ii) providing a concentrate containing an agrichemical active; and
(iii) forming the spray liquid by combining the adjuvant according to the present invention and agrichemical active concentrate with a solvent.

Typically the agrichemical active is a herbicide, pesticide, fertiliser or growth promoter (such as a plant hormone) or other crop protection active.

Typically, when the agrichemical active is water-soluble it is supplied by the manufacturer as an aqueous concentrate. Preferred water-soluble pesticide/herbicide actives include glyphosate, glufosinate, chiormequat, diquat, paraquat and hormone weedkillers such as Mecoprop, 2,4-D, clopyralid, CMPP or MCPA for instance as a potassium, sodium or amine (preferably isopropyl amine) or other water soluble salt.

The active may alternatively be supplied in another conventional form, such as oil in water emulsion, suspension concentrate and water dispersible grains.

Water insoluble pesticide/herbicide actives include Bromoxynil. Ioxynil and Pentanochior. Others include Fenoxaprop-ethyl oil in water emulsion, Quizalofop-ethyl suspension concentrate, Fluroxypyr emulsifiable concentrate, Metsulfuron-methyl water dispersible granules and Isoproturon suspension concentrate.

Other aspects and preferred forms are disclosed in the specification and/or defined in the appended claims, forming a part of the description of the invention.

In essence, embodiments of the present invention stem from the realization that spray drift agents, hitherto provided as aqueous concentrates can be provided in non-aqueous form. Furthermore, there is the further realisation that there are advantages or synergies available from combining spray drift agents with wetting agents. Without wishing to be bound by theory it is believed that the combination of surfactant with particles of spray drift agent is particularly desirable because individual particles become surrounded by surfactant molecules, resulting in repulsive forces keeping the particles separated when they hydrolyse on contact with water.

Advantages provided by the present invention comprise the following:
contributes to compliance with regulations governing chemical handling and spray drift containment;
provides for rapid dispersion/hydrolysis of drift retardant into spray solution without excessive agitation required;
provides for the addition of at least two adjuvant compounds, a wetting agent and a drift retardant;
more efficient use of chemicals in economic terms, and in terms of quantity;
easier to store, handle, mix and meter.

### EXAMPLES

The present invention will be further described with reference to the following non-limiting examples of a spray liquid adjuvant according to the present invention, and the following drawings:

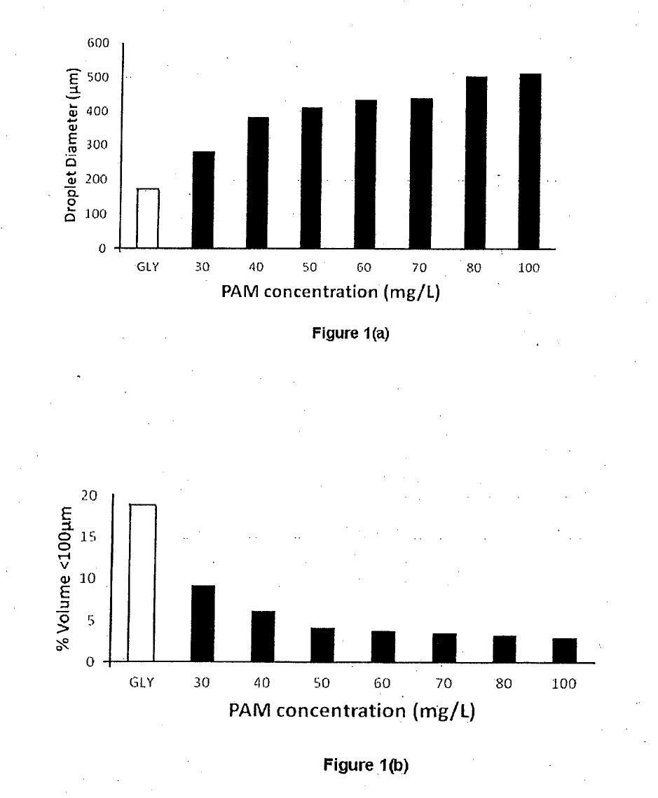

FIG. 1 illustrates plots of XR11002 Nozzle Droplet size Measurements in terms of PAM concentration (mg/L) against droplet diameter (micron) Dv50 (FIG. 1(a)) and PAM concentration (mg/L) against % Volume <100 micron (FIG. 1(b)); where all adjuvant test solutions contained 0.032% super wetter

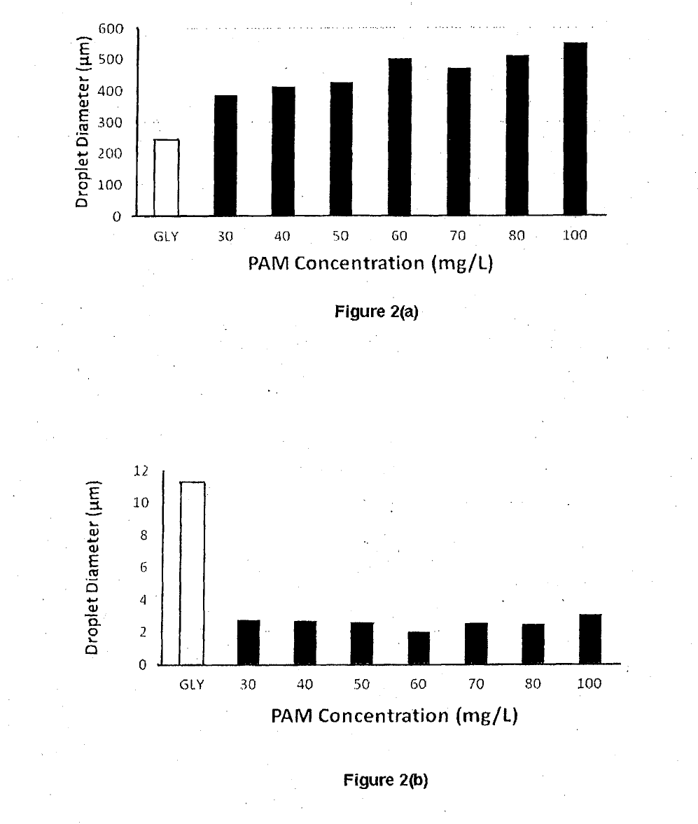

FIG. 2 illustrates plots of TT11002 Nozzle Droplet size Measurements in terms of PAM concentration (mg/L) against droplet diameter (micron) Dv50 (FIG. 2(a)) and PAM concentration (mg/L) against droplet diameter <100 micron (FIG. 2(b)); where all adjuvant test solutions contained 0.032% super wetter and

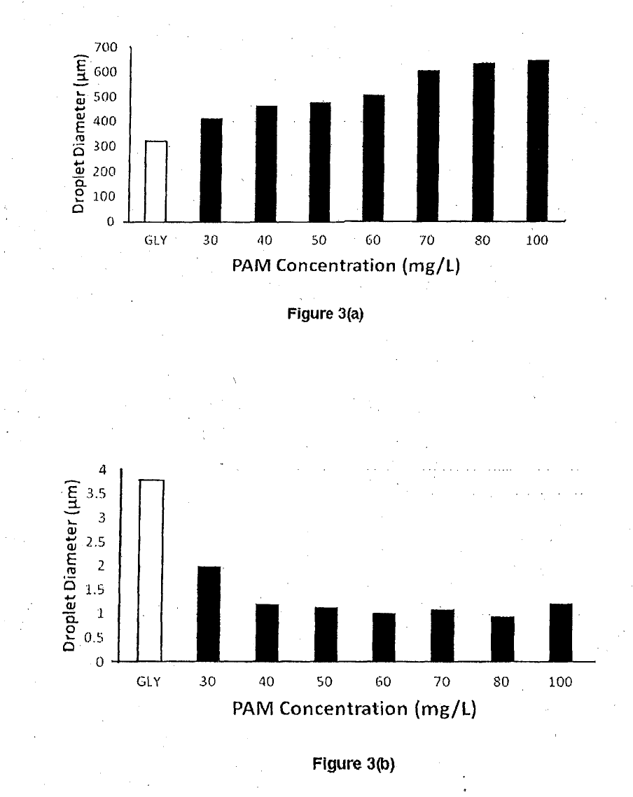

FIG. 3 illustrates plots of AIXR11002 Nozzle Droplet size Measurements in terms of PAM concentration (mg/L) against droplet diameter (micron) Dv50 (FIG. 3(a)) and PAM concentration (mg/L) against droplet diameter <100 micron (FIG. 3(b)) where all adjuvant test solutions contained 0.032% super wetter

In particular the examples relate to a combination of a spray drift reduction agent comprising PAM and a non-ionic surfactant comprising a liquid polyether trisiloxane super-wetting agent where the concentration of wetting agent is held constant at 0.032% and the concentration of spray drift reduction agent is varied from 30 to 100 mg/L.

Methodology:

A wind tunnel facility located at the University of Queensland, Gatton Campus was used to determine the atomisation characteristics of the selected hydraulic nozzles and spray mixtures. The facility comprises an open circuit wind tunnel, a transparent working section, a Sympatec laser diffraction analyser and an exhaust air scrubber extraction system.

Measurement was carried out using Sympatec HELOS VARIO Helios laser-diffraction particle-size analyser (Sympatec GmbH, Germany; FIG. 4 with R7 lens (0.5-3500 μm Dynamic Size Range). Two gantries were used to independently position the laser and the nozzle system and allow the emitted spray to be traversed through the laser beam so that the entire spray plume was measured. Droplet size was measured 150 mm away from the nozzle to ensure full break-up of the spray at the measurement point. A compressed air cylinder and pressure regulator was used to set the nozzle pressure which was measured by a calibrated pressure gauge placed close to the nozzle. Wind speed during all tests was 24 km/hr.

The following descriptors as set out in Table 2 have been used to indicate the droplet size for each treatment:

TABLE 2
Droplet Size Descriptors

| | |
|---|---|
| Dᵥ₁₀ | 10% of the volume of the spray is contained in droplets smaller |
| | than this diameter. |
| Dᵥ₅₀ | 50% of the volume of the spray is contained in droplets smaller |
| | than this diameter. This value is commonly called the Volume |
| | Median Diameter (VMD). |
| Dᵥ₉₀ | 90% of the volume of the spray is contained in droplets smaller |
| | than this diameter. |
| Vol < X | Percentage of the total volume contained in droplet sizes less |
| | than X μm. |

The nozzles tested included an XR11002, TT11002 and AIXR11002 and the operating pressure was set to 300 kPa. The nozzles were selected as of those that were designed to produce small, medium and large droplet size, corresponding to large, medium and small drift potential. While the nozzles used are well known to those skilled in the technology, a brief description of the characteristics of each nozzle are included in Table 3 below:

TABLE 3
Characteristics of nozzles used in droplet size tests

| Nozzle type | Features | Applications | | |
|---|---|---|---|---|
| XR11002 | Extended Range Nozzle | Contact | Systemic | Drift |
| | Spray angle 110° | Product | Product | Management |
| | Liquid rate 0.2 USGPM @40 psi (275 kPa) | Excellent | Good | Good |
| | Excellent spray distribution over a wide | Good* | Very Good* | Very Good* |
| | range of pressures: 15-60 psi (100- | | | |
| | 400 kPa) | | | |
| | Excellent coverage at higher pressures, | | | |
| | lower drift at lower pressures | | | |
| TT11002 | Turbo Teejet Nozzle | Pre-emergence surface applied | | |
| | Spray angle 110° | herbicides - minimum spray | | |
| | Liquid rate 0.2 USGPM @40 psi (275 kPa) | pressure of 15 psi (100 kPa) | | |
| | Tapered edge wide angle flat spray | Post-emergence contact | | |
| | pattern for uniform coverage in broadcast | herbicides -- typical spray | | |
| | spraying | pressure of 40 psi (2.75 bar) | | |
| | Large, rounded internal passage to | and higher | | |
| | minimize clogging | Contact | Systemic | Drift |
| | Resistance to corrosive solutions | Product | Product | Managemet |
| | Good wear characteristics | Very | Very | Very Good |
| | Larger droplets for less drift: 15-90 psi | Good | Good | |
| | (100-600 kPa) | Good* | Excellent* | Very Good* |
| | Blockage-free passage for less clogging | | | |
| AIXR11002 | Air Induction Nozzle | Contact | Systemic | Drift |
| | Spray angle 110° | Product | Product | Management |
| | Liquid rate 0.2 USGPM @40 psi (275 kPa) | Good | Excellent | Excellent |
| | offers better drift management with large | | | |
| | droplet size | | | |
| | Removable pre-orifice | | | |
| | Available in seven tip capacities with a | | | |
| | wide operating pressure range: 15-90 psi | | | |
| | (100-600 kPa) | | | |

*At pressures below 30 psi (200 kPa)

The measurements for droplet size testing are summarised in Table 4 below:

TABLE 4
Droplet size measurement test program

| | Concentration of product | | |
|---|---|---|---|
| | Glyphosate | Spray Drift | |
| Mix | 450 (% v/v) | Agent (ppm) | Wetting agent (%) |
| 1 | 2 | — | — |
| 2 | 2 | 30 | 0.032 |
| 3 | 2 | 40 | 0.032 |
| 4 | 2 | 50 | 0.032 |
| 5 | 2 | 60 | 0.032 |
| 6 | 2 | 70 | 0.032 |
| 7 | 2 | 80 | 0.032 |
| 8 | 2 | 100 | 0.032 |

Results:

A summary of all droplet size tests is presented in Table 5. The Dv50 and percentage of the spray volume less than 100 μm for the 3 nozzle types are illustrated in FIGS. 1 to 3.

TABLE 5
Droplet size test results

| | | | | | | REDUC- |
|---|---|---|---|---|---|---|
| NOZZLE | | DV 10 | Vol < 100 | DV 50 | DV90 | TION % |
| XR11002 | GLY | 73 | 19.05 | 175 | 309 | — |
| XR11002 | 30 | 103 | 9.34 | 284 | 722 | 51 |
| XR11002 | 40 | 128 | 6.21 | 383 | 1464 | 67 |
| XR11002 | 50 | 152 | 4.24 | 412 | 1593 | 78 |
| XR11002 | 60 | 161 | 3.84 | 436 | 1738 | 80 |
| XR11002 | 70 | 164 | 3.57 | 441 | 1709 | 81 |
| XR11002 | 80 | 178 | 3.35 | 506 | 1797 | 82 |
| XR11002 | 100 | 189 | 3.06 | 516 | 1687 | 84 |
| TT11002 | GLY | 94 | 11.3 | 249 | 474 | — |
| TT11002 | 30 | 172 | 2.73 | 388 | 658 | 76 |
| TT11002 | 40 | 180 | 2.68 | 415 | 742 | 76 |
| TT11002 | 50 | 183 | 2.58 | 429 | 813 | 77 |
| TT11002 | 60 | 218 | 1.98 | 503 | 1067 | 82 |
| TT11002 | 70 | 201 | 2.56 | 472 | 897 | 77 |
| TT11002 | 80 | 216 | 2.45 | 512 | 1128 | 78 |
| TT11002 | 100 | 213 | 3.07 | 553 | 1268 | 73 |
| AIXR11002 | GLY | 149 | 3.8 | 323 | 530 | — |
| AIXR11002 | 30 | 189 | 1.99 | 415 | 733 | 48 |
| AIXR11002 | 40 | 220 | 1.2 | 467 | 838 | 68 |
| AIXR11002 | 50 | 227 | 1.14 | 480 | 846 | 70 |
| AIXR11002 | 60 | 241 | 1.02 | 511 | 896 | 73 |
| AIXR11002 | 70 | 274 | 1.1 | 609 | 1301 | 71 |
| AIXR11002 | 80 | 291 | 0.95 | 640 | 1436 | 75 |
| AIXR11002 | 100 | 289 | 1.22 | 652 | 1200 | 68 |

Results summarised in Table 5 and depicted in FIGS. 1 to 3 show that the wetting agent/drift retardant formulation increases the Volume Mean Diameter (Dv50) for all concentrations and all nozzles tested when compared with the glyphosate herbicide only. Similar increases are shown for Dv10 and Dv90.

The volume of driftable spray droplets (<100 μm) is reduced at all concentrations of wetting agent/drift retardant formulation tested when compared with the control mix containing only 2% glyphosate.

It is well known that the addition of a wetting agent to spray solutions results in decreased droplet sizes and increased drift. It appears however that the combination of polysiloxane super wetter and wetting agent results in droplet size increase at low to moderate polyacrylamide concentrations of 30 to 60 mg/L with reduction in driftable droplets of 50 to 80% for the XR11002 nozzle. Similar performance is observed for the TT11002 and AIXR11002 nozzles.

### CONCLUSIONS

From the examples set out above the following conclusions can be drawn:
(1) the presence of wetting agent combined with drift retardant in spray solutions containing 2% glyphosate herbicide reduces the volume of spray droplets <100 μm by 50 to 80% at application rates of 30-60 ppm using an XR11002 nozzle, and
(2) the combination of wetting agent and drift retardant as a liquid dispersion product shows the influence of both wetter and drift retardant. Formulation and application dose rate for the super wetter and PAM should enable optimal performance characteristics for both wetter and drift retardant properties.

Further scope of applicability of embodiments of the present invention will become apparent from the detailed description given herein. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific, embodiments are to be understood to be illustrative of the many ways in which the principles of the present invention may be practiced. In the following claims, means-plus-function clauses are intended to cover structures as performing the defined function and not only structural equivalents, but also equivalent structures.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. A spray liquid adjuvant comprising a spray drift agent dispersed in a non-ionic surfactant.

2. A spray liquid adjuvant according to claim 1 wherein the combination of spray drift agent and non-ionic surfactant exhibits a synergistic effect.

3. A spray liquid adjuvant comprising a spray drift agent at a concentration of between 1 and 50 wt % dispersed in a non-ionic surfactant, the spray drift agent comprising particles of <150 micron.

4. A spray liquid adjuvant according to claim 1 and further comprising an active ingredient dispersed in the non-ionic surfactant

5. A spray liquid adjuvant according to claim 1 wherein the non-ionic surfactant is a wetting agent.

6. A spray liquid adjuvant according to claim 5 wherein the non-ionic surfactant is a super-wetter.

7. A spray liquid adjuvant according to claim 1 wherein the spray drift agent is comprised of one or more polymers formed from a water soluble monomer or monomer blend.

8. A spray liquid adjuvant according to claim 7 wherein the polymer contains from 0.01 to 40 wt % anionic monomer components.

9. A spray liquid adjuvant according to claim 1 wherein the spray drift agent is chosen from the group comprising polyacrylates including visco-elastic polyacrylamides (PAMs) and Carbopol®-type polyacrylamides, polyethylene oxides, poly(vinyl pyrrolidones), polyvinyl alcohol, guar, guar-gum compounds including hydroxyalkyl guar, carboxyalkyl guar, carboxyalkyl hydroxyalkyl guar, cationic guar, hydrophobically modified guar, hydrophobically modified hydroxyalkyl guar, hydrophobically modified carboxyalkyl guar, hydrophobically modified carboxyalkyl hydroxyalkyl guar, hydrophobically modified cationic guar, pectin, alginates, locust bean gum, gum Arabic, gum acacia, carrageenan, carboxyalkyl hydroxyalkyl, starch, gum tragacanth, gum karaya, tara gum, xanthan gum, welan gum succinoglucans, soy lecithin compounds, cellulose and cellulosic materials including hydroxyalkyl cellulose, carboxyalkyl hydroxyalkyl cellulose, carboxyalkyl cellulose, alkyl ethers of cellulose, hydroxyalkyl methyl cellulose, hydrophobically modified hydroxyalkyl cellulose, hydrophobically modified alkyl hydroxyalkyl cellulose, hydrophobically modified carboxyalkyl cellulose, hydrophobically modified alkyl ethers of cellulose, hydrophobically modified hydroxyalkyl methyl cellulose, and derivatives and combinations thereof.

10. A spray liquid adjuvant according to claim 1 wherein the spray drift agent is a visco-elastic polyacrylamide having less than 40% of ionic character and a molecular mass between 10 and 20 million.

11. A spray liquid adjuvant according to claim 1 which further comprises an additive chosen from the group comprising acids, bases, buffers, demulsifiers, non-emulsifiers, foaming agents, antifoaming agents, scale inhibitors, corrosion inhibitors, thickeners, polymer preservatives, bactericides, antioxidants, fluid loss additives, water miscible co-solvents, formation stabilisers, cross-linkers, polymer breakers, gel breakers and combinations thereof.

12. A spray liquid adjuvant according to claim 1 which further includes an additive thickener chosen from the group comprising partially neutralised polyacrylic acid, hydroxypropyl cellulose, highly substituted hydroxypropyl guar, hydrated thickening silica including fumed silica and hydrophobic fumed silica, their functional equivalents, and mixtures thereof.

13. A spray liquid adjuvant according to claim 1, wherein the adjuvant is encapsulated in water-soluble polymer film packaging.

14. A spray liquid formulation comprising:
a spray drift adjuvant according to claim 1,
a carrier solvent, and
an active.

15. A spray liquid formulation according to claim 14 wherein the spray drift agent is present in a concentration of between 10 and 200 mg per litre of spray solution.

16. A spray liquid formulation according to claim 14 wherein the active is chosen from agricultural, horticultural, pharmaceutical or veterinary actives, or combinations thereof.

17. A method of forming a spray liquid formulation comprising the steps of:
(i) providing an adjuvant according to claim 1;
(ii) providing a concentrate containing an active; and
(iii) combining the adjuvant and agrichemical active concentrate with a solvent.

18. A method according to claim 17 wherein the active is an aqueous concentrate of one or more agrichemical actives.
